(19) United States
(12) Patent Application Publication
(10) Pub. No.: US 2013/0175347 A1
(43) Pub. Date: Jul. 11, 2013

(54) DEVICE FOR IDENTIFYING AN ANIMAL AND CORRESPONDING MANUFACTURING DEVICE

(71) Applicants: Johan Decaluwe, Laval (FR); Jean-Jacques Hilpert, Vitre (FR)

(72) Inventors: Johan Decaluwe, Laval (FR); Jean-Jacques Hilpert, Vitre (FR)

(73) Assignee: Allflex Europe, Vitre (FR)

(21) Appl. No.: 13/816,013

(22) PCT Filed: Aug. 3, 2011
(86) PCT No.: PCT/EP2011/063407

§ 371 Date: Mar. 25, 2013

(30) Foreign Application Priority Data
Aug. 9, 2010 (FR) 1056520

(51) Int. Cl. G06K 19/077; G06K 19/07

(52) U.S. Cl. CPC G06K 19/07786; G06K 19/0723; G06K 19/07724
USPC 235/492; 425/500

(57) ABSTRACT

The invention relates to a device for identifying an animal bearing at least one identifier of said animal. According to the invention, such a device comprises at least one planar UHF antenna (141) and at least one planar electronic component (142) that extends in one and the same plane corresponding to a surface of a flexible film (14) secured to a planar element of said device.

### 1. FIELD OF THE INVENTION

The field of the invention is that of the control and/or identification of animals.

More specifically, the invention pertains to a novel device for identifying animals, also called a tag, comprising a means of electronic identification.

Such identification devices are made especially to be placed on animals for intended for consumption. Such animals may be cattle, sheep, pigs, goats or poultry, or any other animal species.

### 2. PRIOR ART

The identification of livestock has been made obligatory in many countries to ensure the tracking of cattle and guarantee the origin of animals intended especially for consumption.

Thus, in order to ensure its traceability, an animal is classically identified by means of a tag, for example fixed to its ear and formed by a male part and a female part designed to be irreversibly associated with each other.

Such a tag comprises a tagging surface, on which pieces of data by which the animal can be identified are mentioned through printing, etching, laser marking or any other means known to those skilled in the art. Thus, classically, a tag carries an identification number enabling the animal to be tracked throughout its existence.

Ear tags made of plastic, at least partially made of polyurethane for example, are presently the most widely used tags. Indeed, such tags have good properties of flexibility, thus causing the least possible inconvenience to the animal in its movements and preventing it from getting injured. The use of deformable material prevents the animal's ear from getting torn, which may occur for example when the tag applied to the animal's ear gets stuck in a fence or in the branches of a tree, etc.

Some of these tags incorporate electronic identification devices such as RFID (radio frequency identification) devices, as described for example in the European patent application EP 2 191 715 filed on behalf of the present Applicant.

Generally, in RFID tags, the RFID device is totally encapsulated in the female part of the tag during the molding of this female part. The RFID component can also be fashioned in the male part. These tags are generally toroidal.

Unfortunately, one drawback of these toroidal tags is that they are generally relatively bulky and liable to deteriorate or be affected by corrosion. Besides, apart from the problem of the animal's comfort, the problem related to the volume and weight of these tags can also increase the duration of cicatrization of the animal and/or hamper the normal development of the ear.

Furthermore, the encapsulation of toroidal RFID devices is complex and costly.

Besides, while the tags generally have good properties of flexibility, these properties are nevertheless limited by the toroidal shape, which may cause injuries in the animal according to its movements.

There is therefore a need for a compact electronic identification device and a novel technique which can be used for the simple and economical integration of the RFID device into a compact electronic identification device.

### 3. SUMMARY OF THE INVENTION

The invention proposes a novel solution in the form of a device for identifying an animal bearing at least one identifier of the animal.

According to the invention, a device for identifying of this kind, or tag, comprises at least one planar UHF antenna and at least one planar electronic component, storing at least one first piece of identifier information, said antenna and said component extending in a same plane corresponding to a surface of a flexible film fixedly joined to a planar element of said device.

Thus, the invention proposes a novel device for identifying, or tag, the volume of which is reduced through the use of a planar UHF antenna and an electronic component integrated into a film fixedly joined to a planar element, i.e. the planar UHF antenna and the electronic component are not superimposed but are side-by-side with each other on a surface of the flexible film.

This makes it especially possible for a flexible film to be wound on a spool, the thickness formed by the film and the elements that it carries being small, enough, for example of the order of 0.1 to 1 mm.

Indeed, a device for identifying according to the invention takes the form of a fixed joining of planar elements. Thus, the volume pertaining to the integration of an electronic component is optimized as compared with the classic toroidal electronic component. Since the device for identifying according to the invention is relatively planar, the risks of corrosion are furthermore reduced.

Apart from the compactness-related aspect, the approach of the invention is particularly advantageous in that it reduces the cost of a device for identifying because the planar UHF antennas have reduced costs and the fixed joining of the planar element to the film is simplified. A UHF antenna of this kind (at 300 to 3000 MHz) also mitigates the saturation of the VHF frequency band (30 to 300 MHz) dedicated to landline or mobile telephony applications and to television applications, while at the same time providing for high transmission quality for applications to the identification of animals.

Besides, the use of a flexible film carrying electronic components needed to identify the animal also increases the overall flexibility of the device.

A flexible film of this kind is an element of very small thickness, which especially may be a film made out of a classic material bearing the antenna, or a sheet of paper, on which the antenna can be printed by means of a conductive ink. It is also characterized by a reduced weight, leading to an overall reduction of the size of the device for identifying and providing a solution to the problem of cicatrization of the animal's ear.

Besides, according to a preferred embodiment, the planar element can protect the film carrying the planar UHF antenna and the planar electronic component. According to this embodiment, the planar UHF antenna and the electronic component do not appear visually outside the device for identifying.

Advantageously, the device for identifying comprises a male part and/or a female part comprising a tagging support, said planar element being fixedly joined to a first surface of said tagging support.

Thus, the electronic identification element can be integrated equally well into the male part or the female part of the device for identifying. The male part and the female part, irreversibly assembled with each other, form the device for identifying according to the invention.

Such an element must indeed be capable of supporting a tagging operation according to an appropriate technique (laser tagging, printing, etching, etc).

The fastening of the planar element can be done by any means enabling the planar element to be held efficiently on the device, especially at high temperature and/or when there are various adverse weather conditions. These means include gluing, soldering, clipping on, embedding, sealing, folding at least a part of said element, etc.

Advantageously, the identifier of the animal is also marked on a second surface of said tagging support by means of a second piece of information.

This second piece of information can be identical to or associated with (for example through a mathematical function) the first piece of information stored in electronic form in said at least one electronic component.

In this way, one tag can carry the same identifier several times, or several identifiers linked to one another so as to identify the same animal.

Thus, a “classic” tagging of the identifier (laser tagging, printing, etching, etc) can be done on one face of the tagging surface and the other face can carry the planar element fixedly joined to the film bearing at least one UHF planar element and a planar electronic component also tagged with the identifier of the animal

According to one embodiment, the flexible film is perforated with an aperture at its center, the planar UHF antenna being substantially concentric with said aperture.

Thus, in the case of the male part of the device, the perforation at the center enables the passage of a push-rod of a plier applying the device for identifying on the animal.

The invention also pertains to a device for manufacturing a device for identifying described here above. Such a device for identifying comprises:
means for obtaining a film carrying at least one planar UHF antenna and at least one planar electronic component, from a spool carrying a tape constituted by a series of successive films, comprising:
means to reel out a portion of said tape corresponding to at least one film;
means for separating the film from the tape;
means for inserting the film into a mold ;
means for overmolding a planar element of the device by means of the mold.

Thus, the planar UHF element and the planar electronic component carried by the film are encapsulated by overmolding in the planar element, enabling protection and concealment of the identifier of the animal.

Such planar encapsulation presents a simplified and optimized implementation.

According to another embodiment, the device for manufacturing comprises means for perforating holes for positioning said film in a mold, said mold comprising corresponding holding means capable of getting engaged in said holes.

Thus, according to this variant, such a device for manufacturing enables a simple and precise manufacture of a device for manufacturing as described here above. Indeed, the holes enable a precise and low-cost positioning of the film in the mold.

According to a first alternative, the holding means, classically called pins, which are closely together during the positioning of the film in the mold, move apart during the overmolding. The advantage of this alternative is that the planar UHF antenna and the electronic component are completely protected and invisible from the exterior of the device for identifying.

According to a second alternative, the holding means which are closely together during the positioning of the film in the mold do not move apart during the overmolding. The advantage of this alternative is that it increases the precision of positioning of the film in the mold but, in return, portions of the film remain unprotected and visible from the exterior of the device for identifying.

According to another embodiment, the device for manufacturing comprises:
means for molding a plate;
first means for fixed joining said film to said plate;
second means for fixed joining said plate equipped with said film on to said tagging support, the face bearing said film being in contact with said tagging support.

Thus, according to this variant, such a device for manufacturing enables simple manufacture. Indeed, this device for identifying implements a molding and then two successive operations of fixed joining to a device for identifying animals enabling the cost of manufacture of such a device to be reduced.

All these embodiments take advantage of the planar nature of the electronic elements needed to identify the animal and the flexibility of the film carrying them.

### 4. LIST OF FIGURES

Other features and advantages of the invention shall appear more clearly from the following description of particular embodiments, given by way of a simple illustratory and non-exhaustive example, and from the appended figures of which:

FIGS. 1A to 1C illustrate an example of a female part of a device for identifying according to the invention;

FIGS. 2A to 2D illustrate an example of a male part of a device for identifying according to the invention;

FIGS. 3A and 3B illustrate a flexible film comprising at least one planar UHF antenna and one planar electronic component;

FIGS. 4A and 4B illustrate a first embodiment of the invention applied to the female part of the device for identifying according to the invention;

FIGS. 5A to 5E illustrate a second embodiment of the invention applied to the female part of the device for identifying according to the invention;

FIGS. 6A to 6D illustrate a third embodiment of the invention applied to the female part of the device for identifying according to the invention.

### 5. DESCRIPTION OF ONE EMBODIMENT OF THE INVENTION

### 5.1 General Principle

The general principle of the invention relies on the use of planar and flexible electronic identification elements, especially a planar UHF antenna and their fixed joining to a planar element of the device for identifying.

In this way, the device for identifying animals achieves gains in volume, flexibility and manufacturing cost.

Here below, we describe different embodiments of the invention applied to a device for identifying comprising a male part and a female part.

### 5.2 Device for Identifying an Animal

### A) Flexible Film Fixedly Joined to the Female Part

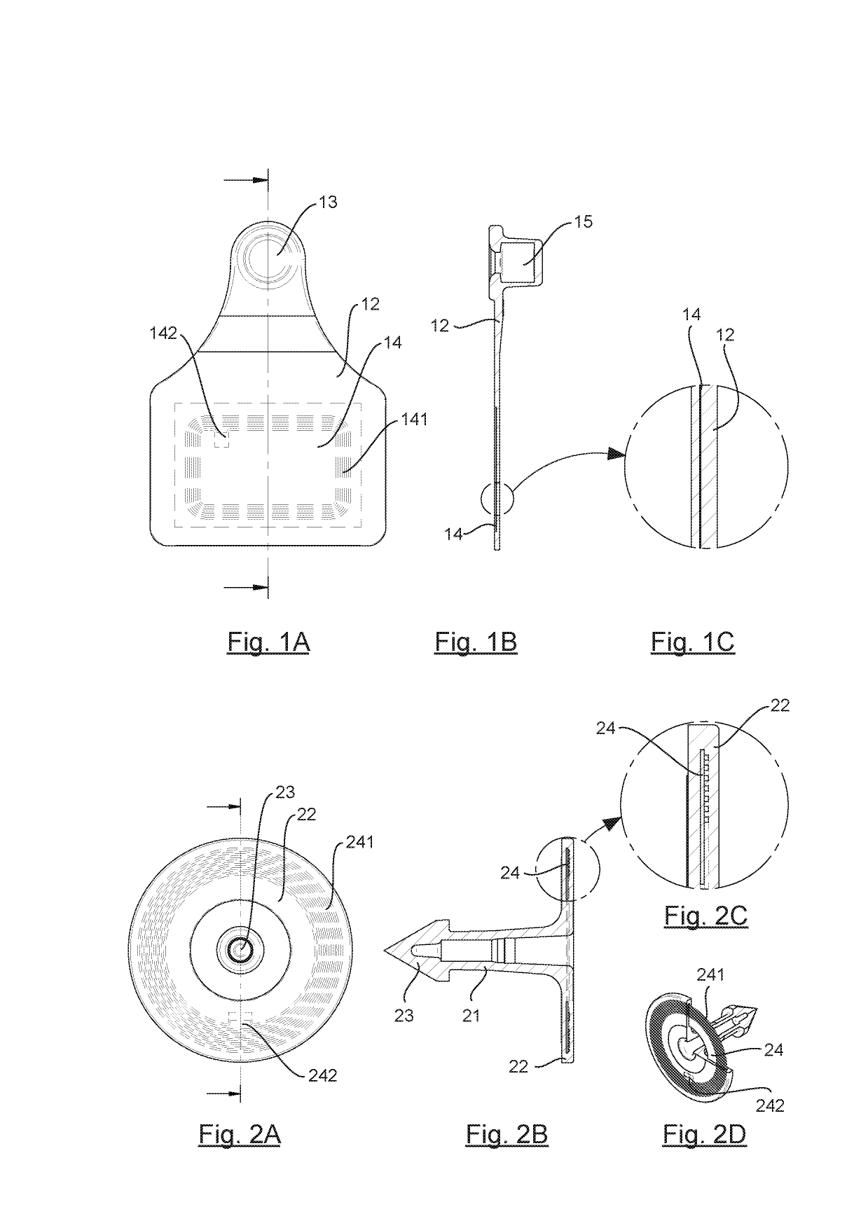

FIGS. 1A to 1C illustrate views (top view, side view and a zoom on the side view respectively) of the female part of a device for identifying comprising a reception button 15 (or head or cap) comprising a cavity 13 that is to receive the tip of the male part and a substantially planar tagging support 12.

The electronic identification elements, corresponding to a planar UHF antenna 141, and a planar electronic component 142 rest, or are extend, on a flexible film 14 housed (shown in broken lines in FIG. 1A), according to one particular embodiment, within a planar element (not shown) of the female part. In other words, the planar UHF antenna and the electronic component are integrated into a film fixedly joined to a planar element, i.e. the planar UHF antenna and the electronic component extend in a same plane corresponding substantially (there may be a layer of bonder for example according to the mode of manufacture) to the surface of the flexible film. In other words, each of these elements is in contact with the flexible film on which they are, for example, glued, drawn, etched, soldered, etc.

### B) Flexible Film Fixedly Joined to the Male Part

FIGS. 2A to 2C illustrate views (top and side views, and a zoom on the side view respectively) of the male part of a device for identifying, comprising a rod 21 extending from a tagging support 22 that is appreciably planar, one end of which terminates in a tip 23 that is to cooperate with the cavity 13 of the female part.

More specifically, according to a first example illustrated by FIGS. 2A (top view), 2B (side view), 2C (zoom on the side view) and 2D (3D view), the tagging support 22 of the male part has electronic identifying elements corresponding to a planar UHF antenna 241 and a planar electronic component 242 resting on a flexible film 24 housed (shown in broken lines in FIG. 2A), according to one particular embodiment, within a planar element (not shown) of the male part.

### C) Planar UHF Antenna

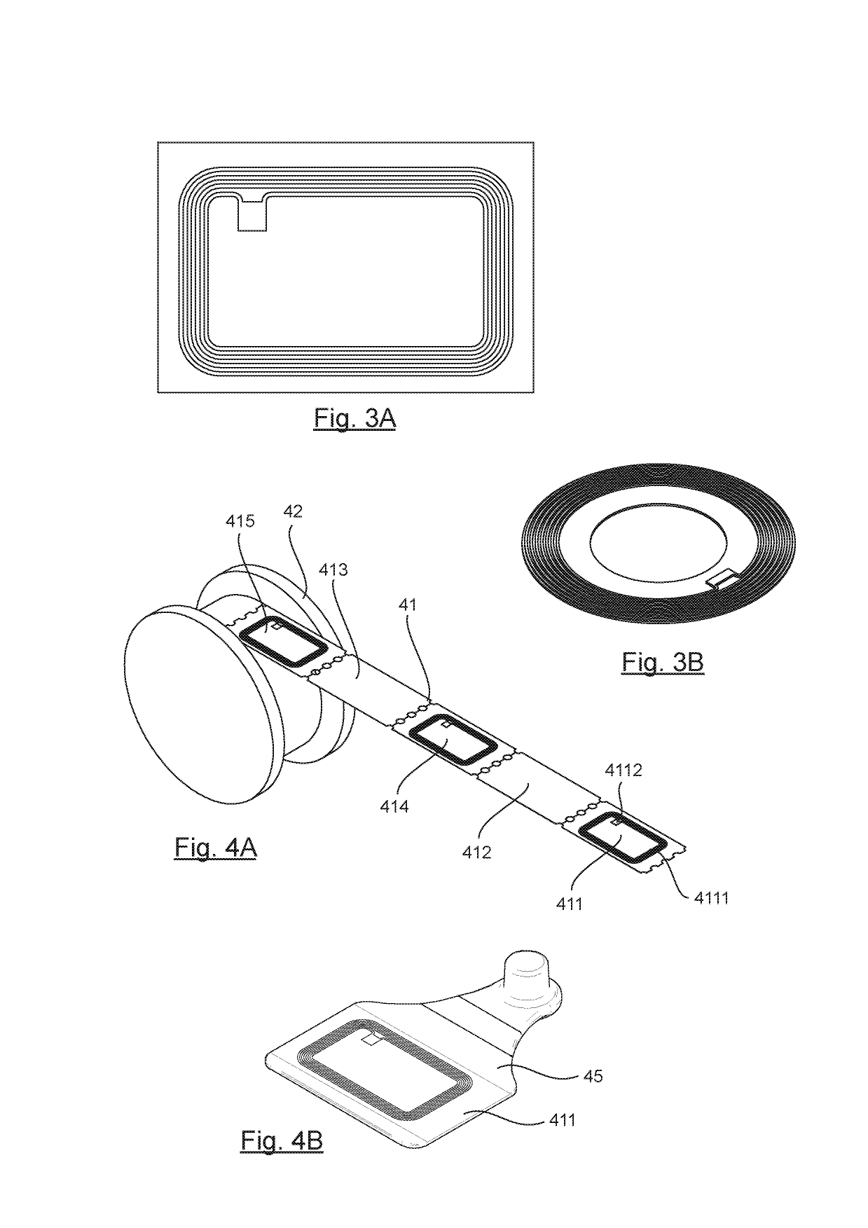

FIGS. 3A and 3B respectively represent two examples of configurations of planar UHF antennas, and their planar electronic components respectively positioned, containing an identifier of the animal.

More specifically, FIG. 3A represents a rectangular planar UHF antenna, the “corners” of the rectangle being rounded. This type of antenna is especially suited to being fixedly joined to a female part of the device for identifying animals shown in FIGS. 1A to 1C.

FIG. 3B represents a planar UHF antenna of a rounded shape. This type of antenna is especially suited to being fixedly joined to a female part of a device for identifying animals in FIGS. 2A to 2D. In particular, when this type of antenna is used, the film, on which the rounded planar UHF antenna and the corresponding planar electronic component rest, is perforated at its center in order to enable the passage of the end of the push-rod of a plier used to apply the male part of the device for identifying to the corresponding female part.

These antennas are conductive.

According to one embodiment, the planar UHF antenna and the planar electronic component are printed directly on a flexible plastic film or a sheet of paper.

According to another embodiment, the planar UHF antenna and the planar electronic component are cut out of a sheet of copper and bonded to the flexible film.

### 5.3 Device for Manufacturing a Device for Identifying

All the embodiments derive advantage from the planeity of the electronic elements needed to identify animals, positioned on a flexible film.

In FIGS. 4A to 6D, the manufacturing devices are shown especially for the manufacture of the female part of the device for identifying, described in detail in FIGS. 1A to 1C. However, such devices are also capable of manufacturing the male part of the device for identifying, described in detail in FIGS. 2A to 2D, provided that the film, on which the planar UHF antenna and the planar electronic component rest, is perforated at its center in order to enable the passage of the end of the push-rod of a plier used to place the male part of the device for identifying on the corresponding female part.

### A) First Embodiment A first embodiment of a device for manufacturing a device for identifying, described in detail here above in FIGS. 1A to 1D, is shown in FIGS. 4A and 4B.

More specifically, the planar electronic elements, namely the planar UHF antenna 4111 and a planar electronic component 4112 are positioned on a film 411. A tape 41 constituted by a series of films 411, 414 and 415 is wound about a mandrel (or a spool). The films 411, 414 and 415 can be spaced out from one another by portions of blank tape 413 and 412, facilitating the processing operations.

According to this particular embodiment, the device for manufacturing comprises means for obtaining at least one film from the tape of films. These means for obtaining comprise means to reel out (not shown) a portion of the tape corresponding to at least one film 411.

Indeed, these means for reeling out unwind the tape by rotation about the mandrel, so that the desired portion, carrying a film, is presented and inserted through insertion means (not shown) into overmolding means of the device for manufacturing (not shown). For example, drums placed on either side of the mold hold the tape in position within the mold. These drums exert pressure on the blank parts (413 and 412) of the tape situated on either side of the film 414 to be overmolded.

The means for obtaining of this device for manufacturing furthermore comprise means for separating the film 411 from the tape. For example, each portion of the tape, whether blank or carrying a film, is separated from the following portion by zones to be punched out 43.

According to one variant, the device according to the invention comprises punches distinct from the mold. According to another variant, the mold intrinsically comprises a membrane on its rim, acting as a punch.

Such a device for manufacturing according to this embodiment can contain a string of modules containing respectively means for reeling out, separating, inserting and strip-molding films. Thus, such a device enables the simultaneous delivery of a series of strip-molded planar elements respectively on flexible planar films each containing a planar UHF antenna and a planar electronic component in which the identifier of the animal is memorized.

### B) Second Embodiment

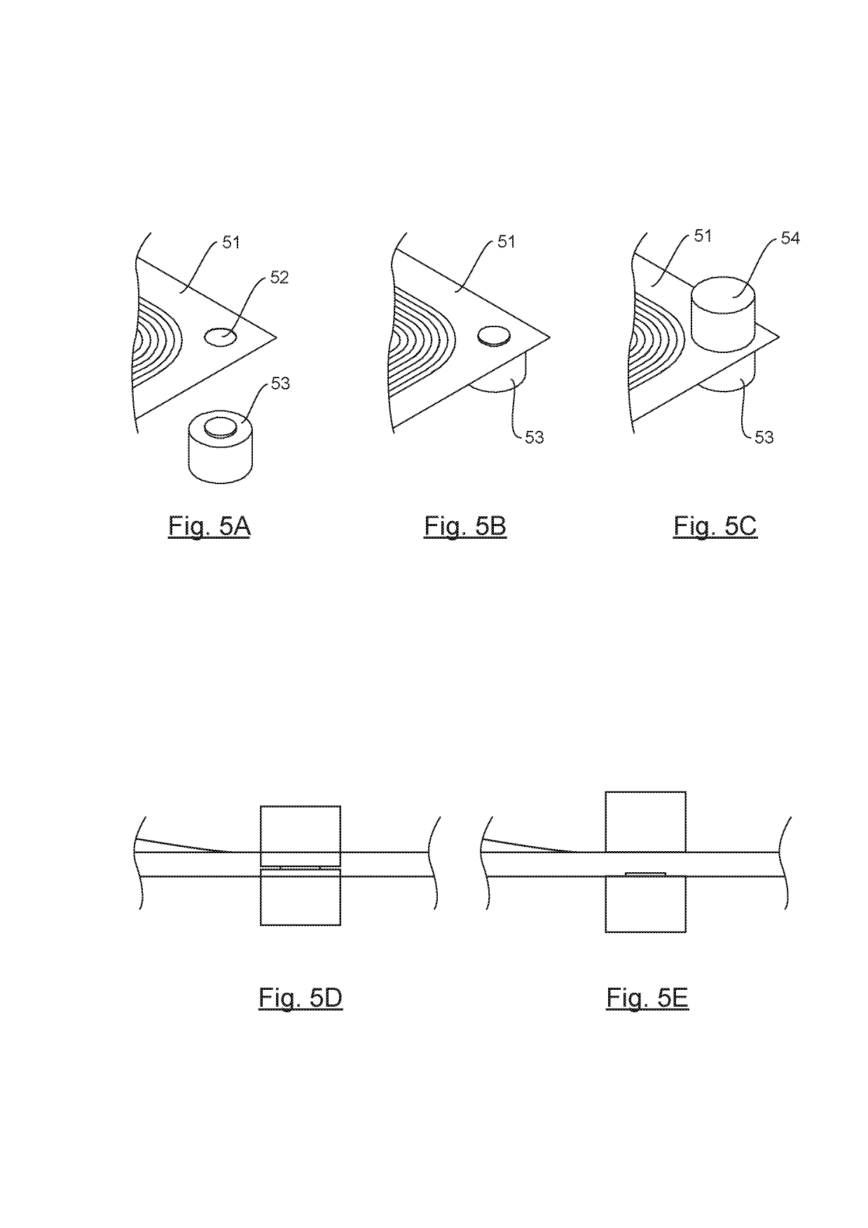

A second embodiment of a device for manufacturing a device for identifying, described in detail in FIGS. 1A to 2D, is shown in FIGS. 5A to 5E.

More specifically, the planar electronic elements, namely the planar UHF antenna and a planar electronic component, are positioned on a film 51. This film 51 is perforated with perforation means in order to comprise holes 52 for positioning the film in the mold of the device for manufacturing.

Reciprocally, the mold contains holding means 53 and 54 corresponding to the holes. These holding means 53 and 54, for example pins, are capable of engaging correspondingly in the holes as illustrated in FIGS. 5B and 5C.

### First Alternative

According to a first alternative, the holding means, which are close together during the positioning of the film in the mold as shown in FIG. 5D, move apart during the overmolding as shown in FIG. 5E. The advantage of this alternative is that the planar UHF antenna and the electronic component are completely protected and invisible from the exterior of the device for identifying.

### Second Alternative

According to a second alternative, the holding means, which are close together during the positioning of the film in the mold, do not move apart (i.e. they remain in the position of FIG. 5D) during the overmolding. The advantage of this alternative is that it increases the precision of positioning of the film in the mold but, in return, portions of the film remain unprotected and visible from the exterior of the identifying device.

### C) Third Embodiment

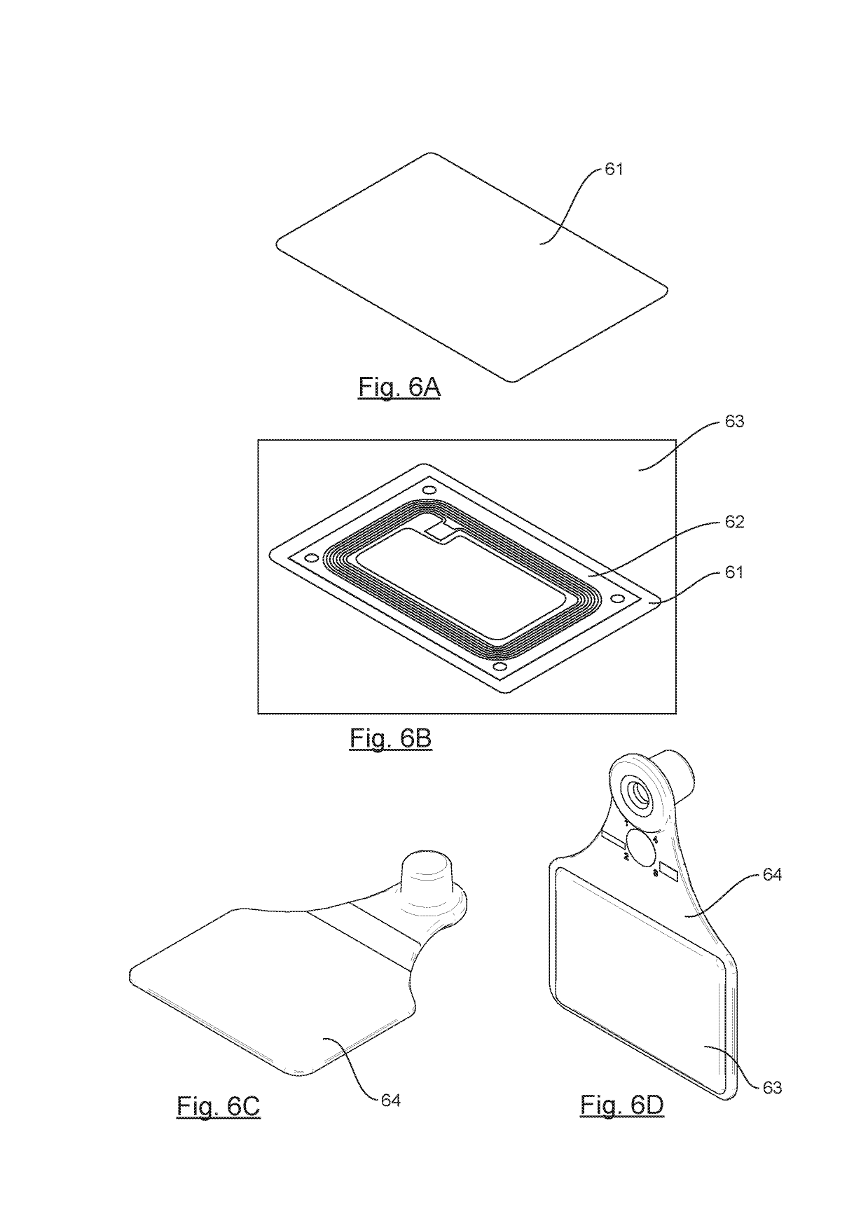

A third embodiment of a device for manufacturing a device for identifying, described in detail here above with reference to FIGS. 1A to 2D, is represented in FIGS. 6A to 6D.

More specifically, according to the embodiment, a plate 61 shown in FIG. 6A is first of all manufactured by molding means of the device for manufacturing according to this third embodiment.

The planar electronic elements, namely the planar UHF antenna and a planar electronic component, are disposed on a film 62.

This film 62 is fixed by first means for fixed joining to the plate 61. The entire film fixedly joined to the plate forms the planar element 63 shown in FIG. 6B.

These means for fixed joining may for example implement an operation of gluing, soldering, or clipping on the film 62 to the plate 61.

This planar element 63 can also be overmolded in an appropriate injection tool.

The device for manufacturing according to this embodiment furthermore comprises second means (shown in FIG. 6D) for fixed joining said plate 61 equipped with said film 62 forming the planar element 63 to a tagging support 64 (shown in FIG. 6C) of the device for identifying to be manufactured.

According to this embodiment, the face of the planar element 63 carrying the film 62 is in direct contact with the tagging support 64. This arrangement permits indeed to protect the film bearing the electronic elements, these elements being between the plate and the tagging support.

According to a preferred variant of this embodiment, the planar element is placed behind the tagging support. In other words, the planar element is suspended from the animal's ear on the face of the tagging support that “faces” the animal.

This preferred arrangement increases the protection of the planar element and thereby the protection of the film carrying the electronic elements. Indeed, this arrangement on the rear face of the tagging support facing the animal prevents frontal impacts with obstacles encountered by the animal.

1. A device for identifying an animal bearing at least one identifier of the animal, comprising:
a flexible film comprising at least one surface;
at least one planar UHF antenna (141); and
at least one planar electronic component (142);
wherein the at least one planar electronic component is configured to store at least one first piece of identifier information;
wherein said antenna and said component extend in a same plane corresponding to the surface of the flexible film and are fixedly joined to a planar element of said device.

2. The device according to claim 1, comprising a first part comprising a tagging support having a first tagging surface, and in that said planar element is fixedly joined to the first tagging surface.

3. The device according to claim 2, wherein the identifier information is also marked on a second tagging surface of said tagging support by means of a piece of information identical to the piece of identifier information.

4. The device according to claim 1, wherein:
said flexible film is perforated with an aperture at its center; and
the planar UHF antenna is substantially concentric with said aperture.

5. A device for manufacturing a device for identifying an animal, comprising:
means for obtaining a film carrying at least one planar UHF antenna and at least one planar electronic component from a spool carrying a tape constituted by a series of successive films, comprising:
means to reel out a portion of said tape corresponding to at least one film; and
means for separating said film from said tape;
means for inserting said film into a mold; and
means for overmolding a planar element of said device by means of said mold.

6. A device for manufacturing a device for identifying an animal, comprising means for perforating holes for positioning a film in a mold, said mold comprising corresponding holding means capable of engaging in said holes.

7. A device for manufacturing a device for identifying an animal, comprising:
means for molding a plate having a plate face;
first means for fixed joining a film to said plate face; and
second means for fixed joining said plate equipped with said film on to a tagging support, the plate face bearing said film being in contact with said tagging support.
